(19) United States
(12) Patent Application Publication
(10) Pub. No.: US 2011/0023028 A1
(43) Pub. Date: Jan. 27, 2011

(54) VIRTUALIZATION SOFTWARE WITH DYNAMIC RESOURCE ALLOCATION FOR VIRTUAL MACHINES

(75) Inventors: Thyaga Nandagopal, Edison, NJ (US); Thomas Woo, Short Hills, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: ALCATEL-LUCENT USA INC., Murray Hill, NJ (US)

(21) Appl. No.: 12/563,668

(22) Filed: Sep. 21, 2009

Related U.S. Application Data
(60) Provisional application No. 61/228,649, filed on Jul. 27, 2009.

(51) Int. Cl. G06F 9/455

(52) U.S. Cl. 718/1

(57) ABSTRACT

In one embodiment, a system has two or more working computers, each running one or more working virtual machines (VMs), and a protection computer running corresponding protection VMs. A management station can change the levels of computer resources specified in resource-configuration files for the protection VMs, and virtualization software can re-read the resource-configuration files and change the allocation of computer resources to the protection VMs without having to shut down and re-launch the protection VMs. By initially launching the protection VMs with reduced levels of computer resources, fast and cost-effective failover protection can be provided to the working computers, where the computer resources allocated to a protection VM are enhanced only after the detection of a failure of the corresponding working VM, without having to shut down and re-launch the protection VM.

This application claims the benefit of the filing date of U.S. Provisional Application Ser. No. 61/228,649, filed on Jul. 27, 2009 as attorney docket no. 805142, the teachings of which are incorporated herein by reference in their entirety.

### BACKGROUND OF THE INVENTION

1. Field of the Invention

The invention relates to computers and, in particular, to protection schemes for virtual machines (VMs) running on one or more computers.

2. Description of the Related Art

This section introduces aspects that may help facilitate a better understanding of the invention. Accordingly, the statements of this section are to be read in this light and are not to be understood as admissions about what is prior art or what is not prior art.

On a typical hardware computing device, e.g., a computer, an operating system (OS) (e.g., Windows, Linux) mediates between software applications and the various computer resources (e.g., random-access memory (RAM), hard-disk drives, processors, and network interfaces) needed by those applications. Typically, the OS does not have to contend with any other entity for access to the computer's resources.

Virtualization software permits the creation of two or more virtual machines on a single computer, where each virtual machine (VM) functions as if it were a distinct computer without knowledge of any other VMs running on the same computer. The virtualization software is responsible for allocating the computer's resources to the various VMs. With virtualization software, a single computer can be partitioned into multiple virtual machines, where each VM behaves like a separate computer running its own operating system and its own software applications within its OS.

Failover is the ability of a computer system to automatically continue or resume providing computer services following a software or hardware failure. Failover methods typically associate a working asset, e.g., a computer that is responding to client requests, with a protection asset, e.g., another computer. When the working asset fails, the failover method shifts the working asset's load to the protection asset.

It is desirable to provide fast, cost-effective failover protection to server systems having multiple computers, where each computer can run one or more VMs and each VM can run one or more server applications. Conventional 1+1 protection schemes, where each working computer has a corresponding protection computer, can provide fast failover protection, but can be cost prohibitive for many server systems. Conventional 1:N protection schemes, where all of the working computers are protected by a single protection computer, can be more cost effective, but can be too slow for many server systems due to the time required for conventional virtualization software to configure one or more VMs on the protection computer to be ready to assume the load of the failed working asset.

### SUMMARY OF THE INVENTION

In one embodiment, the invention is a method implemented on a first computer running first virtualization software that enables one or more virtual machines (VMs) to run on the first computer. The first virtualization software accesses a first version of a first resource-configuration file for a first VM to allocate a first level of first-computer resources for the first VM prior to launching the first VM on the first computer. The first virtualization software then accesses a second version of the first resource-configuration file for the first VM, different from the first version, to allocate a second level of the first-computer resources for the first VM, different from the first level, after launching the first VM without shutting down the first VM.

In another embodiment, the invention is a method for a management station of a server system having a first computer running first virtualization software that enables one or more virtual machines (VMs) to run on the first computer. The management station creates, on the first computer, a first version of a first resource-configuration file specifying a first level of first-computer resources for a first VM. The management station instructs the first virtualization software to launch the first VM on the first computer, wherein the first virtualization software reads the first resource-configuration file and allocates the first level of the first-computer resources for the first VM prior to launching the first VM on the first computer. The management station changes the first resource-configuration file to a second version, different from the first version, specifying a second level of the first-computer resources for the first VM, different from the first level. The management station instructs the first virtualization software to re-read the first resource-configuration file, wherein the first virtualization software re-reads the first resource-configuration file and allocates the second level of the first-computer resources for the first VM without shutting down the first VM.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 is a block diagram of a server system according to one embodiment of the present invention;

FIG. 2 is a flow diagram of the operations of the server system of FIG. 1 according to various embodiments of the present invention; and

FIG. 3 is a block diagram of a server system configured according to a complete-distribution method.

### DETAILED DESCRIPTION

In order to protect a server system having one or more working computers, where each working computer runs one or more working virtual machines (VMs), and each VM runs one or more working server applications, a single protection computer can be configured with a protection VM for each working VM, where each protection VM is allocated a reduced level of computer resources. If and when a working asset (e.g., a single working computer or a single VM) fails, then the one or more protection VMs corresponding to the failed working asset can be re-configured with an enhanced level of computer resources, greater than the reduced level, to assume the load of the failed working asset. In this way, 1:N protection can be provided in a cost-effective manner by eliminating the need to allocate, prior to asset failure, enhanced levels of computer resources in the protection computer corresponding to all of the working assets, as in 1+1 protection.

The computer resources for a VM are specified in a dedicated resource-configuration file stored on the corresponding computer. To launch a VM, virtualization software running on the computer reads the resource-configuration file to determine the computer resources that are needed for the VM. The virtualization software then allocates the specified computer resources and launches the VM with those allocated computer resources. Conventional virtualization software reads the resource-configuration file for a VM only once: when the VM is initially launched.

The resource-configuration file for a protection VM can be created to specify a reduced level of computer resources for the protection VM associated with the 1:N protection scheme described above. To launch a protection VM with a reduced level of computer resources, the virtualization software reads the resource-configuration file, allocates the reduced level of computer resources, and then launches the protection VM.

In order to change the computer resources of a running protection VM (e.g., from one with a reduced level of computer resources to one with an enhanced level of computer resources), the resource-configuration file for the VM needs to be changed, for example, by a management station in the server system (or some other entity external to the protection computer running the virtualization software) editing the existing resource-configuration file or replacing it with a different resource-configuration file.

Since conventional virtualization software can read a VM's resource-configuration file only at VM startup, in order to change the computer resources of an already running protection VM from a reduced level to an enhanced level, the virtualization software would have to be instructed to shut down the protection VM and then re-launch the protection VM. In re-launching the protection VM, the virtualization software would read the changed version of the resource-configuration file, allocate the specified enhanced level of computer resources, and re-start the protection VM to operate with the enhanced level of computer resources.

The time that it takes to shut down and then re-launch a protection VM in order to change the protection VM from operating with a reduced level of computer resources to operating with an enhanced level of computer resources can exceed the failover timing requirements of some server systems.

According to certain embodiments of the present invention, conventional virtualization software is modified to enable the virtualization software to re-read the resource-configuration file for an already running VM and to re-allocate as necessary the computer resources for the running VM as specified in that resource-configuration file, without having to shut down the running VM and then re-launch the VM. This capability of virtualization software associated with the present invention enables implementation of protection schemes, such as 1:N protection schemes, that are both fast and cost-effective.

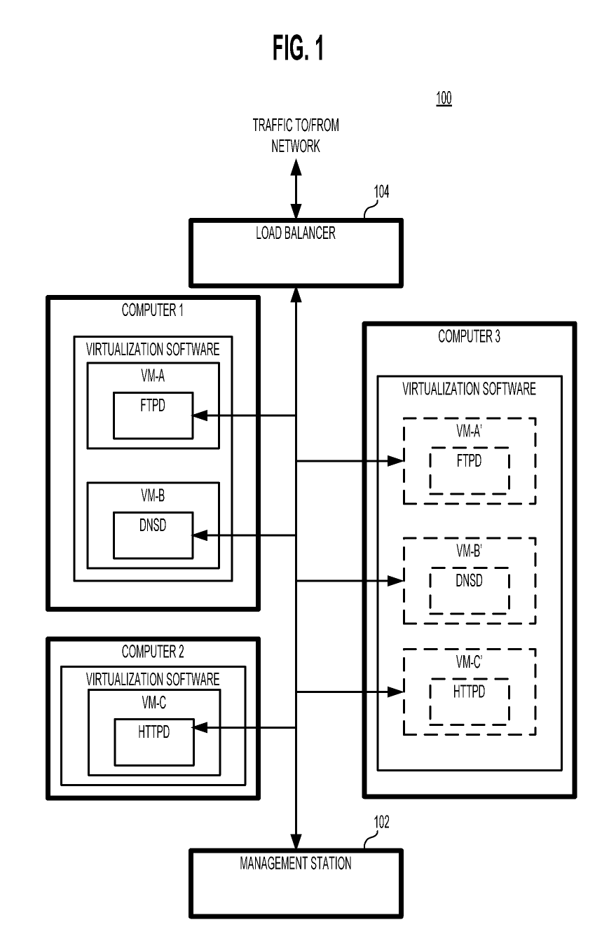

FIG. 1 is a block diagram of a server system 100 according to an exemplary embodiment of the present invention. Server system 100 comprises management station 102, load balancer 104, working computers Computer 1 and Computer 2, and a single protection computer Computer 3.

Working Computer 1 comprises virtualization software running two working VMs: VM-A and VM-B. VM-A is running a file transfer protocol (FTP) server program called FTPD, and VM-B is running a domain name services (DNS) server program called DNSD. Although not shown in FIG. 1, working Computer 1 stores a different resource-configuration file for each of VM-A and VM-B.

Working Computer 2 comprises virtualization software running a single working VM: VM-C, which is running a hypertext transfer protocol (HTTP) server program called HTTPD. Like working Computer 1, working Computer 2 stores a resource-configuration file (not shown) for VM-C. Server system 100 thus offers three computer services: FTP services, DNS services, and HTTP services.

Protection Computer 3 comprises virtualization software running protection VMs VM-A′, VM-B′, and VM-C. VM-A′ runs the FTP server program FTPD, VM-B′ runs the DNS server program DNSD, and VM-C′ runs the HTTP server program HTTPD. Like working Computers 1 and 2, protection Computer 3 stores a different resource-configuration file (not shown) for each of VM-A′, VM-B′, and VM-C′. In this implementation, the protection VMs are already running instances of the server programs prior to failover. In another possible implementation, the appropriate server programs do not get launched until after failover.

Load balancer 104 is responsible for receiving incoming network traffic, distributing that incoming network traffic to the appropriate assets (i.e., server programs, VMs, and computers) in server system 100, receiving outgoing network traffic from those assets, and forwarding that outgoing network traffic to the network.

When server system 100 is initially configured, management station 102 creates (i) the resource-configuration files for the working VMs to specify enhanced levels of computer resources and (ii) the resource-configuration files for the protection VMs to specify reduced levels of computer resources. When management station 102 instructs the different instances of virtualization software running on Computers 1, 2, and 3 to launch the various VMs, the virtualization software on each computer reads the corresponding resource-configuration files, allocates the specified levels of computer resources, and launches the corresponding VMs. As such, prior to any asset failure, working VM-A and VM-B on Computer 1 and working VM-C on Computer 2 are all allocated corresponding enhanced levels of computer resources, while protection VM-A′, VM-B′, and VM-C′ on Computer 3 are all allocated corresponding reduced levels of computer resources. In this way, all of the protection VMs can be launched on a single computer without having to provide Computer 3 with all of the computer resources associated with the sum of the allocated computer resources on Computers 1 and 2.

The current state of a VM is recorded in a set of policies and data structures, referred to herein collectively as a VM file that is stored on the hosting computer. The VM file includes the resource-configuration file for the VM. Management station 102 tracks changes in the VM files of the working VMs on working Computers 1 and 2, and applies those changes to the corresponding VM files of the protection VMs on protection Computer 3. In this manner, the working VM files and the corresponding protection VM files are kept in sync. Note that, depending on the particular implementation, synchronization of the working and protection VM files might or might not include synchronization of the resource-configuration files.

Management station 102 also monitors server system 100 for working-asset failures and assists in protection switching to recover from such failures. Depending on the particular situation, a working-asset failure could be, for example, (i) the failure of a single working program or (ii) the failure of a single working VM running one or more working programs or (iii) the failure of a single working computer running one or more working VMs, each working VM running one or more working programs.

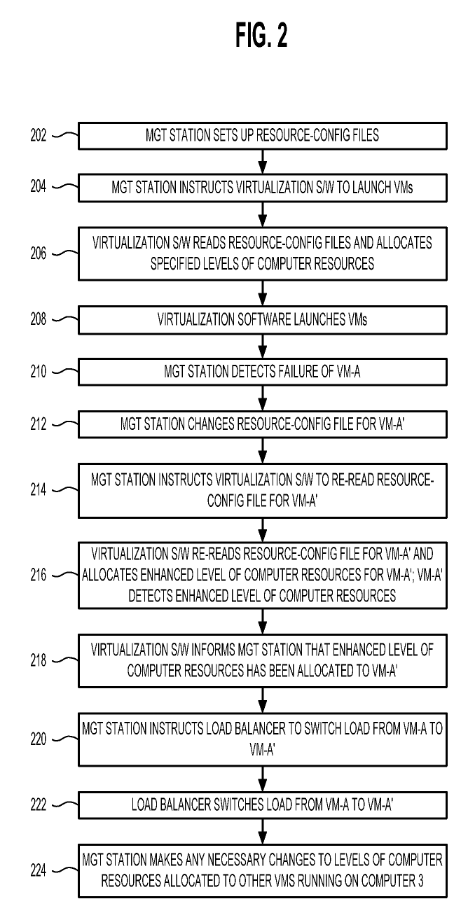

FIG. 2 shows a flow diagram of the operations of server system 100 of FIG. 1 associated with the initial configuration of server system 100 and the subsequent failure of a working asset in server system 100, according to one embodiment of the present invention.

Processing starts with management station 102 of FIG. 1 creating the resource-configuration files for the various VMs (step 202), with (i) the resource-configuration files for the working VMs specifying enhanced levels of computer resources and (ii) the resource-configuration files for the protection VMs specifying reduced levels of computer resources.

Management station 102 then instructs the virtualization software on the various computers to launch the appropriate VMs (step 204). In response, the virtualization software on each computer reads the corresponding resource-configuration files and allocates the specified levels of computer resources for the corresponding VMs (step 206), resulting in (i) enhanced levels of computer resources being allocated on Computer 1 for VM-A and VM-B and on Computer 2 for VM-C and (ii) reduced levels of computer resources being allocated on Computer 3 of VM-A′, VM-B′, and VM-C′.

The virtualization software on each computer then launches the appropriate VMs on Computers 1, 2, and 3 (step 208), resulting in (i) working VM-A, VM-B, and VM-C being launched with enhanced levels of computer resources and (ii) protection VM-N, VM-B′, and VM-C′ being launched with reduced levels of computer resources.

In this particular exemplary scenario, working VM-A fails, and management station 102 detects that failure (step 210). Management station 102 then changes the resource-configuration file for protection VM-A′ on Computer 3 to specify an enhanced level of computer resources (step 212). Management station 102 then instructs the virtualization software on Computer 3 to re-read the resource-configuration file for VM-A′ (step 214).

The virtualization software on Computer 3 re-reads the resource-configuration file for VM-A′ and allocates the specified enhanced level of computer resources of VM-A′, and VM-A′ detects the enhanced level of computer resources, e.g., using conventional plug-and-play technology (step 216). In an alternative implementation, the virtualization software could send specific messages informing VM-A′ about the enhanced level of computer resources.

The virtualization software on Computer 3 notifies management station 102 that the specified enhanced level of computer resources has been allocated to VM-A′ (step 218). Management station 102 then instructs load balancer 104 of FIG. 1 to switch the service load of failed working VM-A to protection VM-A′ (step 220), and, in response, load balancer 104 switches that service load to protection VM-A′ (step 222).

In parallel with steps 212-222, management station 102 determines whether any changes need to be made to the levels of computer resources allocated to any of the other VMs running on Computer 3 and then, as appropriate, makes those changes by initiating steps analogous to steps 212-218 for those other VMs (step 224).

Note that, if management station 102 determines that the levels of computer resources for one or more other VMs running on Computer 3 need to be reduced (e.g., to provide VM-A′ with enough computer resources to operate properly), then those levels of computer resources can be reduced without having to shut down those one or more other VMs. Assume, for example, a scenario in which working VM-C first failed and the level of computer resources allocated for protection VM-C′ was increased to enable protection VM-C′ to handle the load of failed working VM-C. Assume further that working VM-A then fails, where the computer services provided by working VM-A are more important than the computer services provided by protection VM-C′. In that case, management station 102 can reduce the level of computer resources allocated to protection VM-C′ and increase the level of computer resources allocated to protection VM-A′ to enable protection VM-A′ to handle the load of failed working VM-A, without having to shut and re-launch either of VM-C′ or VM-A′.

In the flow diagram of FIG. 2, management station 102 changes the resource-configuration file for VM-A′ (step 212) after detecting the failure of VM-A (step 210). In an alternative embodiment, management station 102 changes the resource-configuration files for all of the protection VMs after the protection VMs have been launched with reduced levels of computer resources, e.g., as part of the process of ensuring that the VM files for the protection VMs are in sync with the VM files for the corresponding working VMs. As long as management station 102 does not instruct the virtualization software on Computer 3 to re-read any of its resource-configuration files (e.g., step 214) until after detecting a working-asset failure, the fact that the resource-configuration files have been changed prior to such failure should not affect the state of the protection VMs. After a working-asset failure does occur, management station 102 can instruct the virtualization software on Computer 3 to re-read the appropriate resource-configuration files to change the allocation of computer resources for the appropriate VMs. In this way, the time that it takes for server system 100 to recover from a working-asset failure can be reduced even further by effectively moving step 212 before step 210.

Although the present invention has been described in the context of particular server systems, e.g., server system 100 of FIG. 1, the present invention is not so limited. In general, the present invention may be implemented in any suitable computer-based system having one or more working computers and one or more protection computers, each computer running one or more virtual machines, each VM running one or more application programs.

Furthermore, the ability of virtualization software to re-read a resource-configuration file after the corresponding VM has been launched and then change the allocation of computer resources for that VM without having to shut down and re-launch the VM can have application in computer-based systems other than in failover protection schemes. In general, such ability can be applied in any suitable situation in which it is desirable to change (i.e., either increase or decrease, as appropriate) the level of computer resources allocated to an already launched VM.

Another method for providing fast, cost-effective failover in a VM environment is to eliminate protection assets altogether, distribute each computer service across all working computers using VM technology, and use one or more load balancers to split the service loads across all working computers. This method is referred to as the complete-distribution method.

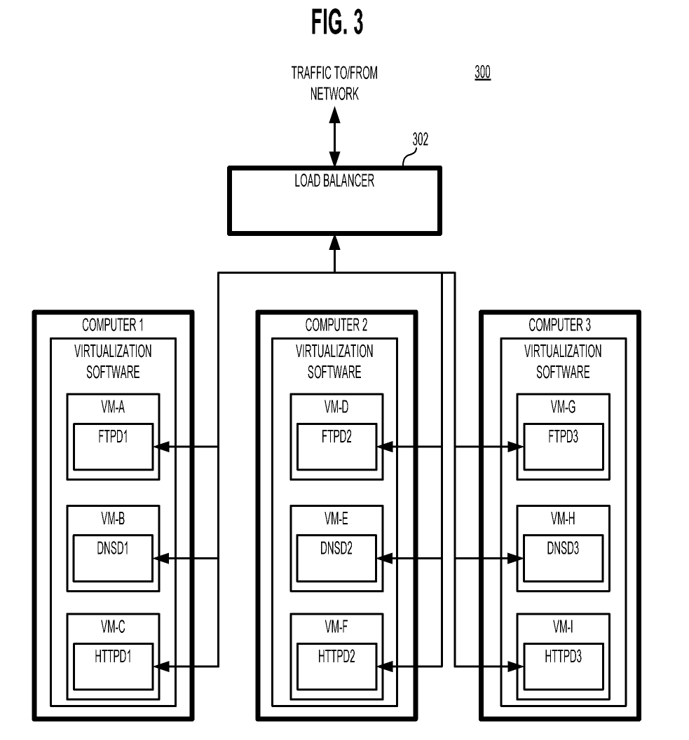

FIG. 3 is a block diagram of a server system 300 configured according to the complete-distribution method. Server system 300 comprises load balancer 302 and three working computers: Computer 1, Computer 2, and Computer 3. Server system 300 comprises no dedicated protection assets. Server system 300 offers three computer services: FTP, DNS, and HTTP. Each of the three computers is running three working VMs: one VM for FTP, a second VM for DNS, and a third VM for HTTP. Load balancer 302 distributes the various service loads across the VMs. For example, load balancer 302 distributes the DNS load among DNS server programs DNSD1, DNSD2, and DNSD3 running on VMs VM-B, VM-E, and VM-H, respectively, where each of these VMs supports one third of the server system's DNS load.

If, for example, VM-B were to fail, then load balancer 302 would re-distribute VM-B′s load among the remaining DNS VMs, i.e., VM-E and VM-H. Assuming that load balancer 302 distributes the load evenly between the remaining DNS VMs, then each of the two remaining DNS VMs would assume one half of VM-B′s third of the server system's DNS load, or an incremental load of ⅙ of the server system's DNS load. If Computer 1 were to fail altogether, then load balancer 302 would perform the same operation described above, but this time for each of the three computer services.

Because virtualization software according to certain embodiments of the present invention can change the level of computer resources allocated to already running VMs without having to shut down and re-launch those VMs, the complete-distribution method of FIG. 3 can be implemented to enhance, as appropriate, the levels of computer resources on the remaining VMs without having to shut down and re-launch any VMs.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium or loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

What is claimed is:

1. A method implemented on a first computer running first virtualization software that enables one or more virtual machines (VMs) to run on the first computer, the method comprising:
(a) the first virtualization software accessing a first version of a first resource-configuration file for a first VM to allocate a first level of first-computer resources for the first VM prior to launching the first VM on the first computer; and
(b) the first virtualization software then accessing a second version of the first resource-configuration file for the first VM, different from the first version, to allocate a second level of the first-computer resources for the first VM, different from the first level, after launching the first VM without shutting down the first VM.

2. The invention of claim 1, wherein:
the first computer is a protection computer in a server system having one or more working computers running one or more working VMs;
the first VM is a first protection VM of one or more protection VMs running on the first computer and corresponding to the one or more working VMs;
the first protection VM corresponds to a first working VM;
the first protection VM and the first working VM are each capable of running a first set of one or more application programs providing a first set of computer services;
the first level of the first-computer resources is a reduced level of the first-computer resources associated with the first working VM providing the first set of the computer services; and
the second level of the first-computer resources is an enhanced level of the first-computer resources associated with the first protection VM providing the first set of the computer services.

3. The invention of claim 2, wherein step (b) is implemented after failure of the first working VM.

4. The invention of claim 3, wherein the server system further comprises a management station that:
(1) detects the failure of the first working VM;
(2) changes the first resource-configuration file from the first version to the second version; and
(3) instructs the first virtualization software to re-read the first resource-configuration file.

5. The invention of claim 4, wherein the method further comprises:
(c) the first virtualization software notifying the management station that the first-computer resources of the second level have been allocated to the first protection VM, wherein the management station instructs a load balancer of the server system to switch a service load from the failed first working VM to the first protection VM.

6. The invention of claim 1, wherein
the first computer is a computer in a server system having one or more other computers running one or more other VMs;
the first VM and an other VM running on an other computer each run a first set of one or more application programs providing a first set of computer services;
the first level of the first-computer resources is a reduced level of the first-computer resources associated with the first set of the computer services being provided by both the first VM and the other VM; and
the second level of the first-computer resources is an enhanced level of the first-computer resources associated with the first set of the computer services being provided by the first VM but not by the other VM.

7. A computer-readable storage medium, having encoded thereon program code, wherein, when the program code is executed by a first computer, the first computer implements first virtualization software that enables one or more virtual machines (VMs) to run on the first computer:
(a) the first virtualization software accesses a first version of a first resource-configuration file for a first VM to allocate a first level of first-computer resources for the first VM prior to launching the first VM on the first computer; and
(b) the first virtualization software then accesses a second version of the first resource-configuration file for the first VM, different from the first version, to allocate a second level of the first-computer resources for the first VM, different from the first level, after launching the first VM without shutting down the first VM.

8. The invention of claim 7, wherein:
the first computer is a protection computer in a server system having one or more working computers running one or more working VMs;
the first VM is a first protection VM of one or more protection VMs running on the first computer and corresponding to the one or more working VMs;
the first protection VM corresponds to a first working VM;
the first protection VM and the first working VM are each capable of running a first set of one or more application programs providing a first set of computer services;
the first level of the first-computer resources is a reduced level of the first-computer resources associated with the first working VM providing the first set of the computer services; and
the second level of the first-computer resources is an enhanced level of the first-computer resources associated with the first protection VM providing the first set of the computer services.

9. The invention of claim 8, wherein the first virtualization software accesses the second version of the first resource-configuration file for the first protection VM after failure of the first working VM.

10. The invention of claim 9, wherein the server system further comprises a management station that:
(1) detects the failure of the first working VM;
(2) changes the first resource-configuration file from the first version to the second version; and
(3) instructs the first virtualization software to re-read the first resource-configuration file.

11. The invention of claim 10, wherein:
(c) the first virtualization software notifies the management station that the first-computer resources of the second level have been allocated to the first protection VM, wherein the management station instructs a load balancer of the server system to switch a service load from the failed first working VM to the first protection VM.

12. A method implemented on a management station of a server system having a first computer running first virtualization software that enables one or more virtual machines (VMs) to run on the first computer, the method comprising:
(a) the management station creating a first version of a first resource-configuration file specifying a first level of first-computer resources for a first VM;
(b) the management station instructing the first virtualization software to launch the first VM on the first computer, wherein the first virtualization software reads the first resource-configuration file and allocates the first level of the first-computer resources for the first VM prior to launching the first VM on the first computer;
(c) the management station changing the first resource-configuration file to a second version, different from the first version, specifying a second level of the first-computer resources for the first VM, different from the first level; and
(d) the management station instructing the first virtualization software to re-read the first resource-configuration file, wherein the first virtualization software re-reads the first resource-configuration file and allocates the second level of the first-computer resources for the first VM without shutting down the first VM.

13. The invention of claim 12, wherein:
the first computer is a protection computer in the server system having one or more working computers running one or more working VMs;
the first VM is a first protection VM of one or more protection VMs running on the first computer and corresponding to the one or more working VMs;
the first protection VM corresponds to a first working VM;
the first protection VM and the first working VM are each capable of running a first set of one or more application programs providing a first set of computer services;
the first level of the first-computer resources is a reduced level of the first-computer resources associated with the first working VM providing the first set of the computer services; and
the second level of the first-computer resources is an enhanced level of the first-computer resources associated with the first protection VM providing the first set of the computer services.

14. The invention of claim 13, wherein step (d) is implemented after failure of the first working VM.

15. The invention of claim 14, wherein, prior to step (c), the management station detects the failure of the first working VM.

16. The invention of claim 15, wherein the method further comprises:
(e) the management station receiving notification from the first virtualization software that the first-computer resources of the second level have been allocated to the first VM; and
(f) the management station instructing a load balancer of the server system to switch a service load from the failed first working VM to the first protection VM.

17. A management station for a server system having a first computer running first virtualization software that enables one or more virtual machines (VMs) to run on the first computer, wherein:
(a) the management station creates a first version of a first resource-configuration file specifying a first level of first-computer resources for a first VM;
(b) the management station instructs the first virtualization software to launch the first VM on the first computer, wherein the first virtualization software reads the first resource-configuration file and allocates the first level of the first-computer resources for the first VM prior to launching the first VM on the first computer;
(c) the management station changes the first resource-configuration file to a second version, different from the first version, specifying a second level of the first-computer resources for the first VM, different from the first level; and
(d) the management station instructs the first virtualization software to re-read the first resource-configuration file, wherein the first virtualization software re-reads the first resource-configuration file and allocates the second level of the first-computer resources for the first VM without shutting down the first VM.

18. The invention of claim 17, wherein:
the first computer is a protection computer in the server system having one or more working computers running one or more working VMs;
the first VM is a first protection VM of one or more protection VMs running on the first computer and corresponding to the one or more working VMs;
the first protection VM corresponds to a first working VM;
the first protection VM and the first working VM are each capable of running a first set of one or more application programs providing a first set of computer services;
the first level of the first-computer resources is a reduced level of the first-computer resources associated with the first working VM providing the first set of the computer services; and
the second level of the first-computer resources is an enhanced level of the first-computer resources associated with the first protection VM providing the first set of the computer services.

19. The invention of claim 18, wherein the management station instructs the first virtualization software to re-read the first resource-configuration file after failure of the first working VM.

20. The invention of claim 19, wherein, prior to the management station changing the first resource-configuration file to the second version, the management station detects the failure of the first working VM.
